(19) United States
(12) Patent Application Publication
(10) Pub. No.: US 2026/0148402 A1
(43) Pub. Date: May 28, 2026

(54) METHOD OF IMAGE PROCESSING AND COMPUTER-READABLE MEDIUM

(71) Applicant: GUANGDONG OPPO MOBILE TELECOMMUNICATIONS CORP., LTD., Dongguan (CN)

(72) Inventors: Cheolkon JUNG, Dongguan (CN); Hui LAN, Dongguan (CN)

(21) Appl. No.: 19/453,727

(22) Filed: Jan. 20, 2026

Related U.S. Application Data
(63) Continuation of application No. PCT/CN2023/109424, filed on Jul. 26, 2023.

(51) Int. Cl. G06T 7/55

(52) U.S. Cl. CPC G06T 7/55; G06T 2207/10024; G06T 2207/10028; G06T 2207/20084

(57) ABSTRACT

According to one aspect of the present disclosure, a method of image processing and a computer-readable medium are provided. The method may include: inputting a first color image and a first depth image into a gradient-estimation network, performing gradient-estimation of the first color image and the first depth image using the gradient-estimation network to generate first depth-edge information, inputting a second depth image and the first depth-edge information into a depth-upsampling network, performing depth upsampling of the second depth image using the first depth-edge information to generate second depth-edge information, inputting the first depth-edge information and the second depth-edge information into a fusion network, fusing the first depth-edge information and second depth-edge information using the fusion network to generate a residual map, and combining the first depth image and the residual map to generate a third depth image.

### CROSS REFERENCE TO RELATED APPLICATION(S)

This application is a continuation of International Application No. PCT/CN2023/109424, filed Jul. 26, 2023, the entire disclosure of which is incorporated herein by reference.

### BACKGROUND

Embodiments of the present disclosure relate to image and/or video processing.

Digital images have become mainstream and are being used in a wide range of applications including digital television, video telephony, and teleconferencing. These digital image applications are feasible because of the advances in computing and communication technologies as well as efficient image processing techniques.

### SUMMARY

According to one aspect of the present disclosure, a method of image processing is provided. The method is applied to a decoder. The method may include inputting, by at least one processor, a first color image and a first depth image into a gradient-estimation network. The method may include performing, by the at least one processor, gradient-estimation of the first color image and the first depth image using the gradient-estimation network to generate first depth-edge information. The method may include inputting, by the at least one processor, a second depth image and the first depth-edge information into a depth-upsampling network. The method may include performing, by the at least one processor, depth upsampling of the second depth image using the first depth-edge information to generate second depth-edge information. The method may include inputting, by the at least one processor, the first depth-edge information and the second depth-edge information into a fusion network. The method may include fusing, by the at least one processor, the first depth-edge information and second depth-edge information using the fusion network to generate a residual map. The method may include combining, by the at least one processor, the first depth image and the residual map to generate a third depth image.

According to another aspect of the present disclosure, a method of image processing is provided. The method is applied to an encoder. The method may include inputting, by at least one processor, a first color image and a first depth image into a gradient-estimation network. The method may include performing, by the at least one processor, gradient-estimation of the first color image and the first depth image using the gradient-estimation network to generate first depth-edge information. The method may include inputting, by the at least one processor, a second depth image and the first depth-edge information into a depth-upsampling network. The method may include performing, by the at least one processor, depth upsampling of the second depth image using the first depth-edge information to generate second depth-edge information. The method may include inputting, by the at least one processor, the first depth-edge information and the second depth-edge information into a fusion network. The method may include fusing, by the at least one processor, the first depth-edge information and second depth-edge information using the fusion network to generate a residual map. The method may include combining, by the at least one processor, the first depth image and the residual map to generate a third depth image.

According to a further aspect of the present disclosure, a non-transitory computer-readable medium storing instructions and a bitstream is provided. The instructions, when executed by a processor, cause the processor to perform the following to generate the bitstream: inputting a first color image and a first depth image into a gradient-estimation network, performing gradient-estimation of the first color image and the first depth image using the gradient-estimation network to generate first depth-edge information, inputting a second depth image and the first depth-edge information into a depth-upsampling network, performing depth upsampling of the second depth image and the first depth-edge information to generate second depth-edge information, inputting the first depth-edge information and the second depth-edge information into a fusion network, fusing the first depth-edge information and second depth-edge information using the fusion network to generate a residual map, and combining the first depth image and the residual map to generate a third depth image.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a detailed block diagram of an exemplary edge-guided depth super-resolution network, according to some embodiments of the present disclosure.

FIG. 2 illustrates a detailed block diagram of an exemplary attention-based multilevel residual block (AMRB), according to some embodiments of the present disclosure.

FIG. 3 illustrates a detailed block diagram of an exemplary channel attention (CA) layer, according to some embodiments of the present disclosure.

FIG. 4 illustrates a detailed block diagram of an exemplary edge-guided depth super-resolution network, according to some embodiments of the present disclosure.

FIG. 5 illustrates a diagram of an exemplary edge map before and after binarization, according to some embodiments of the present disclosure.

FIG. 6A illustrates a flowchart of an exemplary method of image processing, according to some embodiments of the present disclosure.

FIG. 6B illustrates a flowchart of an exemplary method of training an image-processing system, according to some embodiments of the present disclosure.

FIG. 7 is a block diagram illustrating an example of a computer system useful for implementing various embodiments set forth in the disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a.” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of image and/or video processing systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

Depth images have been widely used in scene reconstruction, robotics, and autonomous driving. However, the common depth cameras, e.g., such as Microsoft Kinect and Lidar, cannot obtain high quality and high resolution (HR) depth images. For instance, the resolution of depth images acquired by existing systems may be limited to 512×424. Thus, it is beneficial to reconstruct super-resolution (SR) depth images from low-resolution (LR) depth images. The simplest method for depth SR is image interpolation, e.g., such as bicubic, bilinear and joint bilateral upsampling (JBU). However, the depth images obtained by such methods are usually too smooth, and it is difficult to recover high quality and HR images, especially when the sampling factor is high. To address this problem, some traditional methods have achieved performance improvement by constructing hand-crafted filters or objective functions. However, these kinds of methods are usually useful for the images of specific scenes, and it is difficult to apply these techniques to acquire depth images of real scenes. Color and depth represent different attributes in the same scene, and the HR color image has strong structural similarity to the LR depth image. Therefore, an exemplary color guided depth SR technique is proposed by the present disclosure to achieve further improvements in performance and image quality.

The rapid development of deep learning has been gradually applied to the field of image SR. Due to its powerful feature extraction and representation ability, deep learning methods have achieved a significant improvement in the quality of reconstructed HR depth images. For upsampling of a single depth image, the deep-learning method can estimate the corresponding HR depth image from a single LR depth image by learning the mapping relationship. In the single-image SR reconstruction method (e.g., implemented using a super-resolution convolutional neural network (SRCNN)), three convolutional layers are used to map the LR feature space to the HR feature space. Compared to other techniques. SRCNN has a relatively simple structure and small receptive fields. Thus, its features-learning ability of features may be limited. In the color guided depth SR, features are extracted from the HR color image and the LR depth image, and the depth image is upsampled and reconstructed in detail under the guidance of the HR color image features. However, not all the features in the HR color image are beneficial for depth SR, and the color image also contains unique textures. Consequently, texture copying artifacts may result in a low quality SR image if the useful and useless details in the color image cannot be effectively distinguished.

Existing image reconstruction techniques suffer from various problems. For instance, existing methods may use the LR depth images or the interpolated HR depth images as input of the proposed network, which ignores that both LR depth image and interpolated HR depth image contribute positively to depth SR. Moreover, existing methods lack a target solution to the texture copying artifacts problem, which results in the inability to effectively filter the useless edge information of the color image when the sampling factor is large. Still further, although the edge information for depth SR is mostly obtained from the color image, existing techniques still suffer from selecting valid depth edges from the color image.

To overcome these and other challenges, the present disclosure provides an exemplary edge-guided depth SR network (referred to hereinafter as an “exemplary SR network”), which may be achieved using attention-based hierarchical multi-modal fusion. In contrast to existing techniques, the proposed method extracts features in the color image and estimates a fine edge map by combining the interpolated HR depth image. The LR depth image is upsampled with the guidance of depth gradient to further refine the depth edges to generate the SR depth image after fusion.

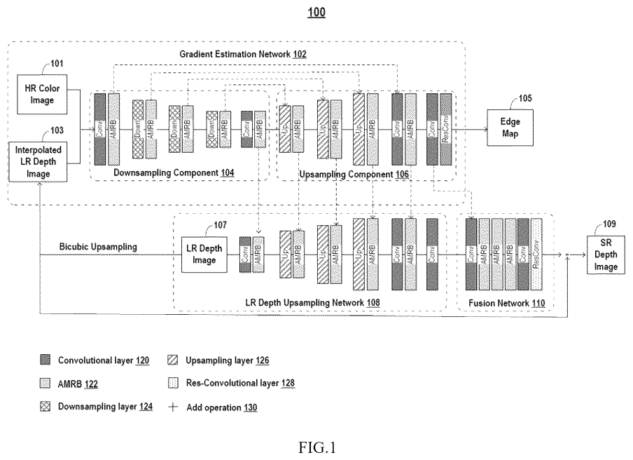

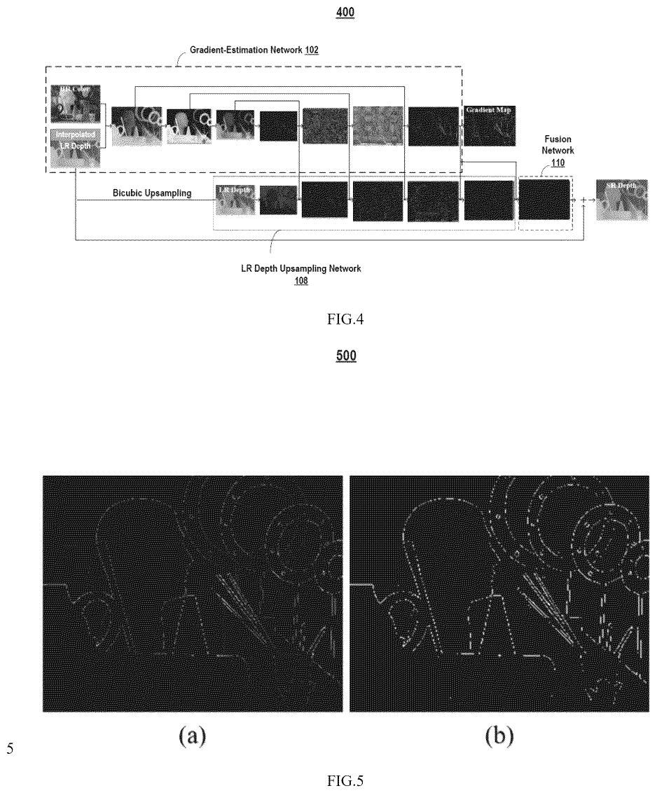

The exemplary SR network described herein may include three subnetworks: a gradient-estimation network, an LR depth upsampling network, and a fusion network. To begin, the HR color image may be converted to gray scale, and the interpolated HR depth image as the input of the gradient-estimation network may be concatenated. An encoder-decoder structure may be used to extract multi-scale texture features, which are used to estimate an edge map with a high degree of accuracy. The interpolated HR depth image may provide depth-structure information and filter out unwanted edge details from the color image. The LR depth upsampling network may be guided by the decoder of the gradient-estimation subnetwork. During LR depth upsampling process, high frequency (HF) details for depth SR are further refined. Then, the fusion network may fuse the multi-modal features extracted from gradient estimation and LR depth upsampling to obtain the residual map between the interpolated depth image and the corresponding HR image. Finally, the HR depth image may be reconstructed by adding the learned residual map to the interpolated depth image. Experimental results demonstrate that the proposed network outperforms the state-of-the-art methods for depth SR in terms of root mean square error (RMSE), peak signal to noise ratio (PSNR), and mean absolute difference (MAD). Additional details of the exemplary edge-guided depth SR network, its subnetworks, and its exemplary operations are provided below in connection with FIGS. 1-7.

FIG. 1 illustrates a detailed block diagram of an exemplary SR network, according to some embodiments of the present disclosure. Referring to FIG. 1, for case of representation, exemplary SR network 100 is shown with a sampling factor ×8. As shown in FIG. 1, exemplary SR network 100 includes, e.g., a gradient-estimation network 102, an LR depth upsampling network 108, and a fusion network 110. Gradient-estimation network 102 may include, e.g., a downsampling component 104 and a upsampling component 106. The hierarchical multi-modal features extracted from color and depth images are concatenated, while the output depth image is obtained by adding the residual map and interpolated HR depth image. The mask is used to preserve depth edges in the loss calculation.

Still referring to FIG. 1, exemplary SR network 100 estimates an SR depth image 109 (e.g., a depth-edge map) from an HR color image 101 and an interpolated LR depth image 103, which is interpolated from the LR depth image 107 (e.g., using bicubic upsampling) to guide the LR depth image upsampling. For instance, exemplary SR network 100 combines edge features in gradient estimation and depth features in LR depth upsampling to generate an accurate residual map. Then, the residual map may be added with the interpolated depth image for SR reconstruction.

In the following description of FIG. 1, HR color image 101 (referred to hereinafter as “color image 101”) is denoted as C^{H}∈R^{(ρh×ρw×3)}). Color image 101 may be converted to grayscale, which is denoted as G^{H} ∈RR^{(ρh×ρw×1)}. The ground truth for SR depth image 109 may be denoted as D_{GT}∈RR^{(ρh×ρw×1)}, which is not included in FIG. 1. LR depth image 107 may be denoted as D^{L}∈RR^{(ρh×ρw×1)}, and the interpolated LR depth image 103 as D^{IL}∈R^{(ρh×ρw×3)}.

We obtain D^{L} from D_{GT} by bicubic downsampling, where p>1 is the upscaling factor (e.g., 2, 4, 8 and 16). We denote the generated residual map as R^{H}∈R^{(ρh×ρw×1)} and the final SR depth image as D_{SR}∈R^{(ρh×ρw×1)}. The output of gradient-estimation network 102 is edge map 105. The ground truth of the edge map 105 is the edge map of D_{GT}, which is denoted as E_{GT}∈R^{(ρh×ρw×1)}. We use Sobel operation to get the edge map 105, which can be expressed as follows:

$${E}_{GT} = Sobel ( {D}_{GT} ) , \qquad ( 1 )$$

where Sobel(·) denotes Sobel operation. The proposed network is based on the residual learning to learn the lost high frequency (HF) component in bicubic interpolation upsampling.

Referring to gradient-estimation network 102, a U-Net based structure with skip connections may be used to extract a set of hierarchical gradient features from HR color image 101 and interpolated LR depth image 103 to generate edge map 105. C^{H} contain a lot of clear but redundant edge information, and D^{IL} can provide rough depth edge reference to prevent texture copying artifacts. We convert C^{H} into intensity scales G^{H} to remove unnecessary color information and concatenated with D^{IL} as input of this subnetwork. As shown in FIG. 1, downsampling component 104 may include five parts that extract features of different receptive fields. For instance, the first part may include one convolutional layer 120 and one AMRB 122, which is used to extract initial features with the original resolution. The next three parts have the same structure, each including one downsampling layer 124 and one AMRB 122 to extract multi-scale semantic features. In some implementations, convolutional layer 120 with stride 2 for downsampling. The last part may include one convolutional layer 120 with stride 1 and one AMRB 122, which further integrates the LR features. This may mirror the feature extraction of the LR depth upsampling network 108. The operations performed by downsampling component 104 may be expressed according to formulas (2)-(5).

$$Conv ( \cdot ) = σ ( W * Input + b ) ; \qquad ( 2 )$$

$${F}_{g} {e}^{1} = AMRB ( Conv ( c ( {G}^{H} , {D}^{IL} ) ) ) ; \qquad ( 3 )$$

$${F}_{g} {e}^{i + 1} = AMRB ( Downsampling ( {F}_{g} {e}^{i} ) ) ; \qquad ( 4 )$$

$$and$$

$${F}_{g} {e}^{5} = AMRB ( Conv ( {F}_{g} {e}^{4} ) ) , \qquad ( 5 )$$

where W and b represent the weight and bias in the first convolutional layer, respectively; * represents the convolution operation; σ is the element-wise rectified linear unit (ReLU) activation function; Conv(·) represents the convolutional layer; c(·) represents the concatenation operation; AMRB(·) represents AMRB 122; and Downsampling(·) means the downsampling layer, which is a convolutional layer 120 with kernel size 3×3 and stride 2. F_{g}e¹ represents the features extracted from input G^{H} and D^{IL}; and F_{g}eⁱ⁺¹ represents the features extracted from F_{g}et by other layers of downsampling component 104, in which i ∈1, 2, 3, when the sampling factor is ×8.

The structure of upsampling component 106 corresponds to that of downsampling component 104, and includes five parts when the sampling factor is ×8. When upsampling and fusing the multi-scale features from downsampling component 104 to prevent the information loss, the useless edge information is further removed to generate edge map 105 with improved accuracy. The first three parts of the upsampling component 106 include one upsampling layer 126 and one AMRB 122. Here, we use the sub-pixel convolutional layer for upsampling. After the first three parts, the edge features are upsampled to the original resolution (e.g., the same resolution as the depth ground truth). The fourth part may include one convolutional layer 120 and one AMRB 122 for integrating HR edge features. Then, an accurate edge map is generated through the fifth part, which includes one convolutional layer 120 and one residual (Res)-convolutional layer 128. The kernel size of all convolutional layers is 3×3, followed by one ReLU layer, except the last one. The convolutional layer without ReLU operation to generate the output image is referred to as the Res-convolutional layer 128.

To reduce the parameters of the proposed network, the number of channels per layer may be to 64, by way of example and not limitation. However, the output channels of Res-convolutional layer 128 may be determined by the output image. The feature maps obtained by each part of upsampling component 106 may be expressed is expressed as follows:

$${F}_{g} {d}^{1} = AMRB ( Upsampling ( c ( {F}_{g} {e}^{4} , {F}_{g} {e}^{5} ) ) ) ; \qquad ( 6 )$$

$${F}_{g} {d}^{2} = AMRB ( Upsampling ( c ( {F}_{g} {d}^{1} , {F}_{g} {e}^{3} ) ) ) ; \qquad ( 7 )$$

$${F}_{g} {d}^{3} = AMRB ( Upsampling ( c ( {F}_{g} {d}^{2} , {F}_{g} {e}^{2} ) ) ) ; \qquad ( 8 )$$

$${F}_{g} {d}^{4} = AMRB ( Conv ( c ( {F}_{g} {d}^{3} , {F}_{g} {e}^{1} ) ) ) ; \qquad ( 9 )$$

$${F}_{g} {d}^{5} = Conv ( {F}_{g} {d}^{4} ) ; \qquad ( 10 )$$

$$and$$

$$E = ResConv ( {F}_{g} {d}^{5} ) , \qquad ( 11 )$$

where Upsampling(·) means upsampling layer 126, and F_{g}dⁱ, i∈1, 2, 3, 4, 5 are the features obtained by each layer and/or part of upsampling component 106; ResConv(·) is the Res-convolutional layer 128; and E is the output edge map 105 of gradient-estimation network 102. Gradient-estimation network 102 can effectively distinguish useful edge information and reconstruct a depth edge map.

Referring to LR depth upsampling network 108 of FIG. 1, although LR depth image 107 has a relatively low resolution, it still may include clear edge information. This plays an important role in preventing texture copying artifacts. Edge map 105 obtained by gradient-estimation network 102 includes redundant edges that are not required for depth SR. Therefore, LR depth upsampling network 108 extracts multi-scale depth features and estimates the residual information guided by the gradient information, which is input by downsampling component 104 and upsampling component 106.

As shown in FIG. 1, the structure of the LR depth upsampling network 108 may be similar to upsampling component 106 in gradient-estimation network 102. For instance, a convolutional layer 120 and an AMRB 122 may be used to extract initial LR depth features. Then, the multi-scale depth features are extracted from the initial LR depth by three upsampling layers 126. The edge information extracted from color image 101 by upsampling component 106 of gradient-estimation network 102 is adaptively fused at each scale. It is worth noting that a sub-pixel convolutional layer may be used for upsampling layer 126, and each upsampling layer 126 is followed by one AMRB 122 to obtain more complex features.

Still referring to LR depth upsampling network 108, after upsampling layers 126, a convolutional layer 120 with one AMRB 122 may be used to further extract the HR depth features and fuse it with the corresponding edge features. Finally, two convolutional layers 120 are used to integrate all types of HR features and generate the final HR depth features. As a non-limiting example, the kernel size of all convolutional layers 120 in LR depth upsampling network 108 is 3×3, while the channels of each layer are 64. For feature extraction and fusion, LR depth upsampling network 108 filters out unwanted edge information in a hierarchical manner to prevent texture copying artifacts. The features extracted by LR depth upsampling network 108 may be expressed according to formulas (12)-(17).

$${F}_{d}^{1} = AMRB ( Upsampling ( c ( {D}^{L} ) ) ) ; \qquad ( 12 )$$

$${F}_{d}^{2} = AMRB ( Upsampling ( c ( {F}_{g} {e}^{5} , {F}_{d}^{1} ) ) ) ; \qquad ( 13 )$$

$${F}_{d}^{3} = AMRB ( Upsampling ( c ( {F}_{g} {d}^{1} , {F}_{d}^{2} ) ) ) ; \qquad ( 14 )$$

$${F}_{d}^{4} = AMRB ( Upsampling ( c ( {F}_{g} {d}^{2} , {F}_{d}^{3} ) ) ) ; \qquad ( 15 )$$

$${F}_{d}^{5} = AMRB ( Conv ( c ( {F}_{g} {d}^{3} , {F}_{d}^{4} ) ) ) ; \qquad ( 16 )$$

$$and$$

$${F}_{d}^{6} = Conv ( Conv ( {F}_{d}^{5} ) ) , \qquad ( 17 )$$

where

$${F}_{d}^{i} ,$$

i ∈1, 2, 3, 4, 5, 6 are the features valued by each layer in the LR depth upsampling network 108.

Still referring to FIG. 1, gradient-estimation network 102 and LR depth upsampling network 108 may be used to extract features from G^{H}, D^{IL} and D^{L}, respectively, and generate HR edge maps and HR depth features. Then, fusion network 110 may combine information from the HR edge features and the depth features to generate an accurate residual map R^{H}. Fusion network 110 may include, e.g., one convolutional layer whose kernel size is 1×1 to compress the 128 channels to 64, three AMRBs 122, and one Res-convolutional layer 128 with a 3×3 kernel size.

$${F}_{d}^{6}$$

and f_{g}d⁵ are the input to fusion network 110 and the output is the residual map R^{H}. Then, R^{H} and D^{IL} are added by add operation 130 to generate SR depth image 109 D_{SR}. The residual map R^{H} and SR depth map 109 may be expressed according to formulas (18) and (19), respectively.

$${R}^{H} = ResConv ( {AMRB}_{3} ( Conv ( c ( {F}_{d}^{6} , {F}_{g} {d}^{5} ) ) ) ) ; \qquad ( 18 )$$

$$and$$

$${D}_{SR} = {R}^{H} + {D}^{IL} , \qquad ( 19 )$$

where AMRB₃(·) refers to three consecutive AMRBs. Additional details of AMRB 122 are provided below in connection with FIG. 2.

FIG. 2 illustrates a detailed block diagram 200 of AMRB 122, according to some embodiments of the present disclosure. Referring to FIG. 2, the shallow features of convolutional neural networks (CNNs) may contain local features such as textures and edges, while the deep features contain mostly semantic information. To implement AMRB 122, the present disclosure combines the benefits of dense block(s) and residual block(s). Under the limited parameters, AMRB 122 reuses the deep and shallow features well, while effectively dealing with the problem of gradient disappearance. CA layer 206 may assign a larger weight to important regions and a smaller weight to unimportant ones.

As shown in FIG. 2, AMRB 122 may include five parts and CA layer 206. The first part of AMRB 122 is a 3×3 convolutional layer 202 to extract the initial features. The next three parts contain two convolutional layers 202 for deeper features extraction. The output of one 3×3 convolutional layer 202 may be input to the next part, while another 3×3 convolutional layer 202 is used to preserve the features of the current deep. The last part is a 1×1 convolutional layer 204, which is used to fuse the output features of all convolutional layers from the second part to the fourth part, realize the feature reuse of different receptive fields, and compress 256 channels to 64. CA layer 206 may be used to preserve more important features during channel compression. Finally, a global residual connection 208 to learn the HF information and ignore the smoothing information that already exists. The outputs from each 3×3 convolutional layer 202 may be expressed according to formulas (20)-(26), the output from 1×1 convolutional layer 204 may be expressed according to formula (27), and the output from CA layer 206 may be expressed according to formula (28).

$${A}^{1} = Conv ( Input ) ; \qquad ( 20 )$$

$${A}^{2 - 1} = Conv ( {A}^{1} ) ; \qquad ( 21 )$$

$${A}^{2 - 2} = Conv ( {A}^{1} ) ; \qquad ( 22 )$$

$${A}^{3 - 1} = Conv ( {A}^{2 - 2} ) ; \qquad ( 23 )$$

$${A}^{3 - 2} = Conv ( {A}^{2 - 2} ) ; \qquad ( 24 )$$

$${A}^{4 - 1} = Conv ( {A}^{3 - 2} ) ; \qquad ( 25 )$$

$${A}^{4 - 2} = Conv ( {A}^{3 - 2} ) ; \qquad ( 26 )$$

$$Output = c ( {A}^{4 - 2} , {A}^{4 - 1} , {A}^{3 - 1} , {A}^{2 - 1} ) ; \qquad ( 27 )$$

$$and$$

$$Output = Ca ( Conv ( Output ) ) + {A}^{1} , \qquad ( 28 )$$

where Input and Output are the input and output features of AMRB 122; A¹ is the initial feature extracted by the first part of AMRB 122; Aⁱ⁻¹ and Aⁱ⁻², i∈2, 3, 4 are the features obtained by the second part to the fourth part of AMRB 122; and Ca(·) denotes CA layer 206.

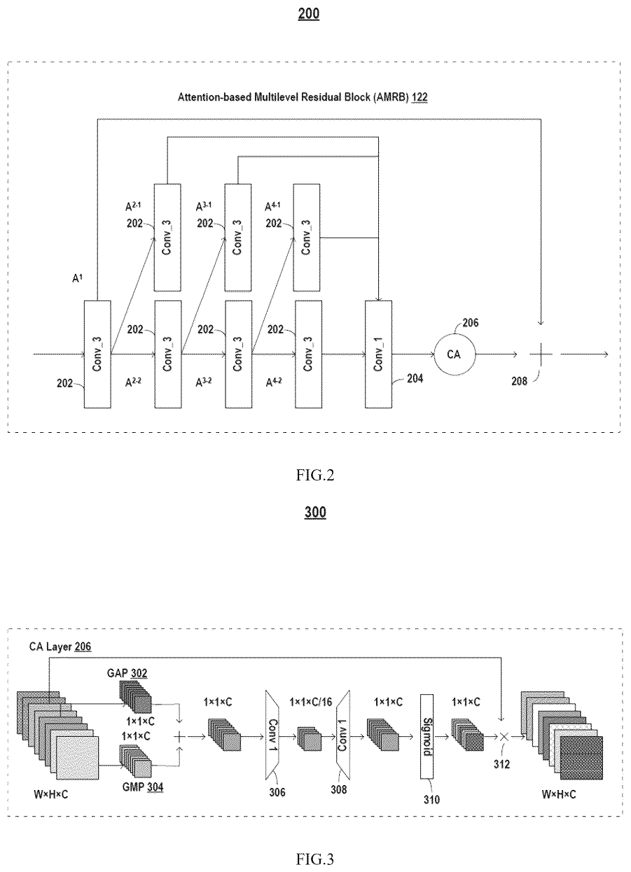

FIG. 3 illustrates a detailed block diagram 300 of an exemplary CA layer 206, according to some embodiments of the present disclosure. Referring to FIG. 3, the channel attention block consists of a global average pooling (GAP) layer 302 and a global max pooling (GMP) layer 304, a squeeze layer/ReLU layer 306 (e.g., the squeeze layer is followed by the ReLU layer), an excitation layer, 308 a sigmoid layer 310, and a multiplier 314.

GAP layer 302 may be used to obtain the overall distribution of all channels, and has feedbacks on every pixel of feature map, while GMP layer 304 has feedbacks on gradient back-propagation only in the feature map with the largest response, which can be used as a supplement to GAP layer 302. After a squeeze and excitation operation, the network performs feature recalibration. Through this mechanism, the network can learn to use global information to selectively emphasize the informative features, while suppressing the less useful features. Finally, the weight of different channels is obtained by sigmoid layer 310, and the feature with CA weight is obtained by multiplying (e.g., by multiplier 314) with the input.

Referring again to FIG. 1, edge map 105 may be used to determine a loss function, which may be used to train gradient-estimation network 102. L₁ and L₂ losses have been commonly used for depth SR. However, both of these loss functions average the difference between the prediction result and its ground truth in a whole image, which is not effective mechanism by which to consider high-frequency components, e.g., such as details and boundaries in depth. Moreover, L₂ loss is sensitive to outliers and cannot rapidly converge in early training.

To solve these problems, the present disclosure proposes mask loss functions that combine mask from the ground truth depth image with L₁ and L₂ losses, which are denoted as ML₁ and ML₂, respectively. The main idea of the proposed mask loss function(s) is to use the depth edge map E_{GT} of the ground truth depth D_{GT} as mask M to constrain L₁ and L₂ losses so that the losses can be calculated separately for edge and smooth regions.

Since the edge map is a vector type, and its proportion is small in terms of information entropy, it is less helpful for loss functions. Thus, binarization of E_{GT} may be performed and the proportion of the edges may be magnified, thereby increasing the constraint on the image edges.

The difference is shown in FIG. 5, which illustrates a diagram 500 of an exemplary edge map before (e.g., (a)) and after (e.g., (b)) binarization, according to some embodiments of the present disclosure. The binarized edge map (e.g., shown at (b) in FIG. 5) depicts edge-regions-of-interest. The binarization operation highlights the edge region of the depth map. For instance, the mask value of the edge region is assigned to 1; otherwise, 0, so that the loss calculation can be performed on the edge and smooth region separately to prevent excessive smoothing of edge regions in reconstructed HR depth image 103.

The original L₁ and L₂ losses may be expressed according to formulas (29) and (30), which are shown below.

$${L}_{1} ( x , y ) = {\vert x - y \vert}^{1} ; \qquad ( 29 )$$

$$and$$

$${L}_{2} ( x , y ) = {\vert x - y \vert}^{2} , \qquad ( 30 )$$

where x and y are the ground truth and SR result, respectively.

The exemplary functions ML₁ and ML₂ implemented to train exemplary SR network 100 may be expressed according to formulas (31) and (32), respectively.

$${ML}_{1} ( x , y ) = {L}_{1} ( M \times x , M \times y ) + {L}_{1} ( ( 1 - M ) \times x , ( 1 - M ) \times y ) ; \qquad ( 31 )$$

$$and$$

$${ML}_{2} ( x , y ) = {L}_{2} ( M \times x , M \times y ) + {L}_{2} ( ( 1 - M ) \times x , ( 1 - M ) \times y ) . \qquad ( 32 )$$

ML₁ may be used for gradient estimation. For depth SR, ML₁ is used to speed up the convergence until the epoch is 120 (e.g., 1≤epoch≤120). Then, ML₂ may be used to generate reconstruction results until training is finished (e.g., 120<epoch≤200) according to formulas (33)-(35).

$${Loss}_{1} = {ML}_{1} ( {E}_{GT} , E ) ; \qquad ( 33 )$$

$$if ( epoch \leq 120 ) \to {Loss}_{2} = {ML}_{1} ( {D}_{GT} , {D}_{SR} ) ; \qquad ( 34 )$$

$$and$$

$$else \to {Loss}_{2} = {ML}_{2} ( {D}_{GT} , {D}_{SR} ) . \qquad ( 35 )$$

At the same time, a structural similarity index (SSIM) loss L_{SSIM} may be used to constrain the structure information of the output depth image. L_{SSIM} compares luminance, contrast, and structure concurrently, according to formulas (36)-(39).

$${L}_{SSIM} ( x , y ) = {{{[ l ( x , y ) ]}^{α} [ c ( x , y ) ]}^{β} [ s ( x , y ) ]}^{γ} ; \qquad ( 36 )$$

$$l ( x , y ) = \frac{2 {μ}_{x} {μ}_{y} + {c}_{1}}{{μ}_{x}^{2} + {μ}_{y}^{2} + {c}_{1}} ; \qquad ( 37 )$$

$$c ( x , y ) = \frac{2 {σ}_{x} {σ}_{y} + {c}_{2}}{{σ}_{x}^{2} + {σ}_{y}^{2} + {c}_{2}} ; \qquad ( 38 )$$

$$and$$

$$s ( x , y ) = \frac{{σ}_{xy} + {c}_{3}}{{σ}_{x} + {σ}_{y} + {c}_{3}} . \qquad ( 39 )$$

where l(x, y) is the luminance part, c(x, y) is the contrast part, and s(x, y) is the structure part, μₓ and μ_{y} are means of x and y, respectively;

$${σ}_{x}^{2} and {σ}_{y}^{2}$$

are variances of x and y; σ_{xy} is the covariance of x and y; and c₁= (k₁L)², c₂=(k₂L)² are the constants, and c₃=c₂/2, L is the range of pixel values:.

For image reconstruction, higher SSIM may be beneficial. Thus, the Loss₃ may be described according to formula (40).

$${Loss}_{3} = 1 - {L}_{SSIM} ( {D}_{GT} , {D}_{SR} ) . \qquad ( 40 )$$

The total loss may be defined according to formula (41).

$$Loss = {Loss}_{1} + {Loss}_{2} + w \times {Loss}_{3} , \qquad ( 41 )$$

where w is the weight for L_{SSIM} and we set w=0.1, k₁=0.01, k₂=0.03.

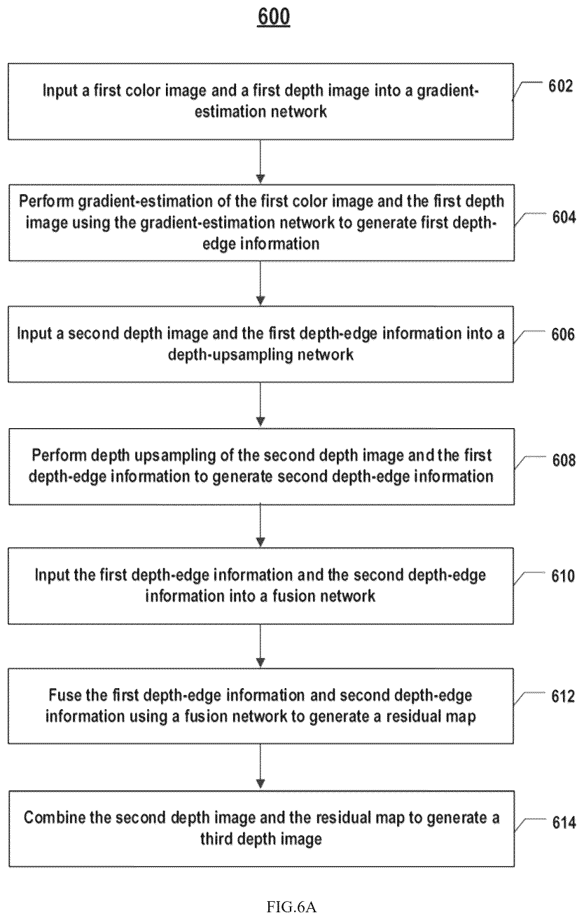

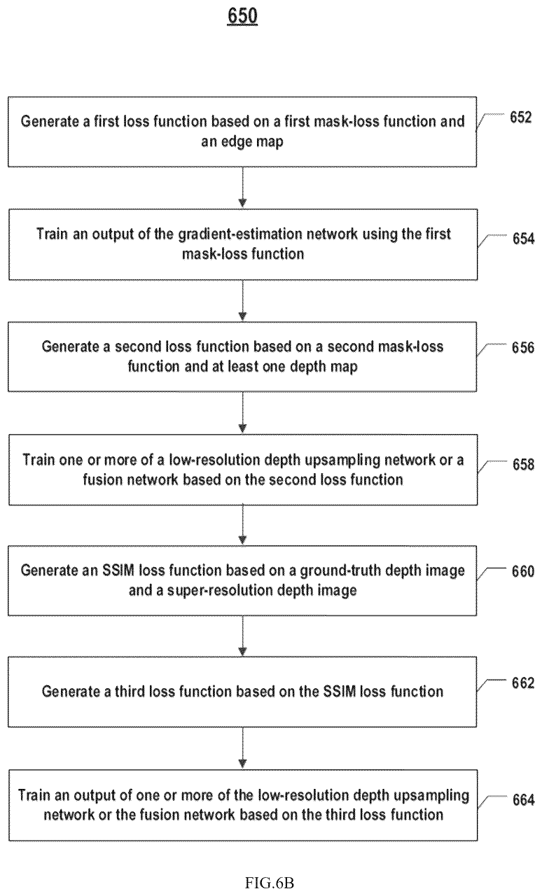

FIG. 6A illustrates a flowchart of an exemplary method 600 of image processing, according to some embodiments of the present disclosure. Referring to FIG. 6A, exemplary method 600 may be implemented by an apparatus, e.g., exemplary SR network 100, gradient-estimation network 102, LR depth upsampling network 108, fusion network 110, and/or computer system 700, just to name a few. Method 600 may include operations 602-614, as described below. It is to be appreciated that some of the steps may be optional, and some of the steps may be performed simultaneously, or in a different order than shown in FIG. 6A.

Referring to FIG. 6A, at 602, the apparatus may input a first color image and a first depth image into a gradient-estimation network. For example, referring to FIG. 1, exemplary SR network 100 estimates an SR depth image 109 (e.g., a depth-edge map) from an HR color image 101 and an interpolated LR depth image 103, which is interpolated from the LR depth image 107 (e.g., using bicubic upsampling) to guide the LR depth image upsampling. For instance, exemplary SR network 100 combines edge features in gradient estimation and depth features in LR depth upsampling to generate an accurate residual map.

At 604, the apparatus may perform gradient-estimation of the first color image and the first depth image using the gradient-estimation network to generate first depth-edge information. For example, referring to FIG. 1, gradient-estimation network 102 may perform gradient estimation based on HR color image 101 and interpolated LR depth image 103.

At 606, the apparatus may input a second depth image and the first depth-edge information into a depth-upsampling network. For example, referring to FIG. 1, LR depth image 107 may be input to LR depth upsampling network 108. Moreover, the first depth-edge information generated output by AMRB 122 of downsampling component 104 and upsampling component 106 of gradient-estimation network 102 may be input to AMRB 122 of the same or similar size in LR depth upsampling network 108.

At 608, the apparatus may perform depth upsampling of the second depth image and the first depth-edge information to generate second depth-edge information. For example, referring to FIG. 1, LR depth upsampling network 108 may perform depth upsampling of LR depth image 107 and the first depth-edge information (e.g., input by AMRB 122 of gradient-estimation network 102).

At 610, the apparatus may input the first depth-edge information and the second depth-edge information into a fusion network. For example, referring to FIG. 1, the first depth-edge information may be input by convolutional layer 120 of upsampling component 106 and the second depth-edge information may be input by LR depth upsampling network 108 into fusion network 110.

At 612, the apparatus may fuse the first depth-edge information and second depth-edge information using a fusion network to generate a residual map. For example, referring to FIG. 1, fusion network 110 may fuse the first depth-edge information and the second depth-edge information.

At 614, the apparatus may combine the first depth image and the residual map to generate a third depth image. For example, referring to FIG. 1, add operation 130) may combine the interpolated LR depth image 103 and the residual map output by fusion network 110 to generate SR depth image 109.

FIG. 6B illustrates a flowchart of an exemplary method 650 of training an image-processing system, according to some embodiments of the present disclosure. Referring to FIG. 6B, exemplary method 650 may be implemented by an apparatus, e.g., exemplary SR network 100, gradient-estimation network 102, LR depth upsampling network 108, fusion network 110, and/or computer system 700, just to name a few. Method 650) may include operations 652-664, as described below. It is to be appreciated that some of the steps may be optional, and some of the steps may be performed simultaneously, or in a different order than shown in FIG. 6B.

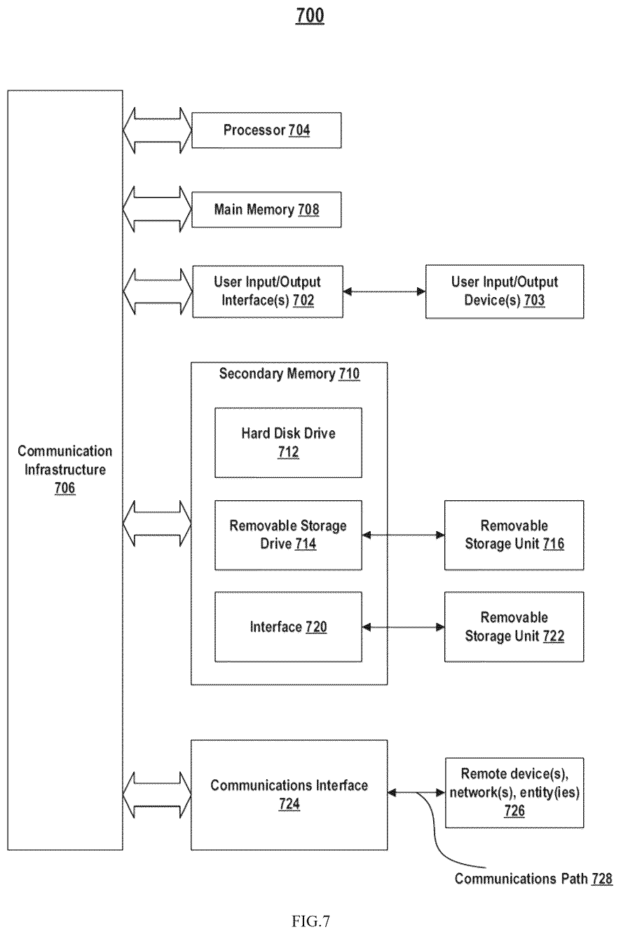

Referring to FIG. 6B, at 652, the apparatus may generate a first loss function based on a first mask-loss function and an edge map. For example, referring to FIG. 7, computer system 700 may generate the first loss function (e.g., Loss₁), that may correspond to formula (33) above, based on a first mask-loss function (e.g., formula (31)) and edge map 105.

At 654, the apparatus may train an output of the gradient-estimation network using the first mask-loss function. For example, referring to FIGS. 1 and 7, computer system 700 may train gradient-estimation network 102 using Loss₁ (e.g., formula (33)). In other words, Loss₁ may be applied to the output of gradient-estimation network 102, e.g., namely, edge map 105.

At 656, the apparatus may generate a second loss function based on a second mask-loss function and at least one depth map. For example, referring to FIG. 7, computer system 700 may generate the second loss function (e.g., Loss₂), which may correspond to formulas (34) and (35) above, based on the first mask-loss function (e.g., formula (31)), interpolated LR depth map 103, and SR depth map 109.

At 658, the apparatus may train one or more of a low-resolution depth upsampling network or a fusion network based on the second loss function. For example, referring to FIG. 7, computer system 700 may train one or more of LR depth upsampling network 108 and/or fusion network 110 based on Loss₁ (e.g., formulas (34) and (35)). In other words, computer system 700 may train an output (e.g., SR depth image 109) of LR depth upsampling network 108 and/or fusion network 110 using Loss₂.

At 660, the apparatus may generate an SSIM loss function based on a ground-truth depth image and a super-resolution depth image. For example, referring to FIG. 7, computer system 700 may generate an SSIM loss function, which may correspond to formula (36) above based on interpolated LR depth image 103 (e.g., ground truth depth image) and SR depth image 109.

At 662, the apparatus may generate a third loss function based on the SSIM loss function. For example, referring to FIG. 7, computer system 700 may generate a third loss function (e.g., Loss₃), which may correspond to formula (40), based on the SSIM loss function (e.g., formula (36).

At 664, the apparatus may train an output of one or more of the low-resolution depth upsampling network or the fusion network based on the third loss function. For example, referring to FIG. 7, computer system 700 may train one or more of LR depth upsampling network 108 and/or fusion network 110 based on Loss₃.

Various embodiments can be implemented, for example, using one or more computer systems, such as computer system 700 shown in FIG. 7. One or more computer system 700 can be used, for example, to implement method 600 of FIG. 6A and/or method 650 of FIG. 6B. For example, computer system 700 may perform method 600 and/or method 650 so that the edge map and/or SR depth map may be used for 3D video compression, where a 3D video is a combination of color and depth videos. For 3D video compression, if the color and depth videos are all high-resolution (HR), the compressed video data may contain a huge number of bits, which is not conducive to transmission. However, computer system 700 may downsample the HR depth video to the LR one in downsampling part (e.g., the encoder for video compression). Then, computer system 700 may compress the HR color video and LR depth video by 3D video coding, e.g., like 3D-HEVC, to obtain the compressed HR color video and LR depth video. Finally, computer system 700 may upsample the LR depth video to the original resolution guided by the compressed HR color video. Using the proposed method(s), computer system 700 may generate a reconstructed 3D video using fewer bits than existing techniques.

Still referring to FIG. 7, computer system 700 can be any well-known computer capable of performing the functions described herein. Computer system 700 includes one or more processors (also called central processing units, or CPUs), such as a processor 704. Processor 704 is connected to a communication infrastructure 706 (e.g., a bus). One or more processors 704 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702.

Computer system 700 also includes a main (or primary) memory 708, such as random-access memory (RAM). Main memory 708 may include one or more levels of cache. Main memory 708 has stored therein control logic (i.e., computer software) and/or data. Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive. Removable storage drive 714 may interact with a removable storage unit 716. Removable storage unit 716 includes a computer usable or readable storage device having stored thereon computer software (control logic) and/or data. Removable storage unit 716 may be a floppy disk, magnetic tape, compact disk, DVD, optical storage disk, and/any other computer data storage device. Removable storage drive 714 reads from and/or writes to removable storage unit 716 in a well-known manner.

According to an exemplary embodiment, secondary memory 710) may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720) may include a program cartridge and cartridge interface (such as that found in video game devices), a removable memory chip (such as an EPROM or PROM) and associated socket, a memory stick and universal serial bus (USB) port, a memory card and associated memory card slot, and/or any other removable storage unit and associated interface.

Computer system 700 may further include a communication (or network) interface 724. Communication interface 724 enables computer system 700 to communicate and interact with any combination of remote devices, remote networks, remote entities, etc. (individually and collectively referenced as 726). For example, communication interface 724 may allow computer system 700 to communicate with remote devices 726 over communication path 728, which may be wired and/or wireless, and which may include any combination of LANs, WANs, the Internet, etc. Control logic and/or data may be transmitted to and from computer system 700 via communication path 728.

In an embodiment, a tangible apparatus or article of manufacture comprising a tangible computer useable or readable medium having control logic (software) stored thereon is also referred to herein as a computer program product or program storage device. This includes, but is not limited to, computer system 700, main memory 708, secondary memory 710), and removable storage units 716 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of the present disclosure using data processing devices, computer systems and/or computer architectures other than that shown in FIG. 7. For example, embodiments may operate with software, hardware, and/or operating system implementations other than those described herein.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as a processor of video-processing system 250. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of image processing is provided. The method may include inputting, by at least one processor, a first color image and a first depth image into a gradient-estimation network. The method may include performing, by the at least one processor, gradient-estimation of the first color image and the first depth image using the gradient-estimation network to generate first depth-edge information. The method may include inputting, by the at least one processor, a second depth image and the first depth-edge information into a depth-upsampling network. The method may include performing, by the at least one processor, depth upsampling of the second depth image using the first depth-edge information to generate second depth-edge information. The method may include inputting, by the at least one processor, the first depth-edge information and the second depth-edge information into a fusion network. The method may include fusing, by the at least one processor, the first depth-edge information and second depth-edge information using a fusion network to generate a residual map. The method may include combining, by the at least one processor, the first depth image and the residual map to generate a third depth image.

In some embodiments, the gradient-estimation may be performed by the gradient-estimation network using at least one AMRB. In some embodiments, the AMRB may include a first convolutional layer of a first dimension, a second convolutional layer of a second dimension smaller than the first dimension, and a channel attention layer.

In some embodiments, the fusion network may fuse the first depth-edge information and the second depth-edge information to generate the residual map using at least one AMRB and a residual convolution al layer.

In some embodiments, the first depth image may be associated with a first resolution. In some embodiments, the second depth image may be associated with a second resolution lower than the first resolution. In some embodiments, the third depth image may have a third resolution equal to the first resolution.

In some embodiments, the method may include interpolating, by the at least one processor, the second depth image to generate the first depth image.

In some embodiments, the second depth image may be interpolated using bicubic upsampling to generate the first depth image.

According to another aspect of the present disclosure, a system for image processing is provided. The system may include at least one processor and memory storing instructions. The memory storing instructions, which when executed by the at least one processor, may cause the at least one processor to input a first color image and a first depth image into a gradient-estimation network. The memory storing instructions, which when executed by the at least one processor, may cause the at least one processor to perform gradient-estimation of the first color image and the first depth image using the gradient-estimation network to generate first depth-edge information. The memory storing instructions, which when executed by the at least one processor, may cause the at least one processor to input a second depth image and the first depth-edge information into a depth-upsampling network. The memory storing instructions, which when executed by the at least one processor, may cause the at least one processor to perform depth upsampling of the second depth image and the first depth-edge information to generate second depth-edge information. The memory storing instructions, which when executed by the at least one processor, may cause the at least one processor to input the first depth-edge information and the second depth-edge information into a fusion network. The memory storing instructions, which when executed by the at least one processor, may cause the at least one processor to fuse the first depth-edge information and second depth-edge information using a fusion network to generate a residual map. The memory storing instructions, which when executed by the at least one processor, may cause the at least one processor to combine the first depth image and the residual map to generate a third depth image.

In some embodiments, the gradient-estimation may be performed by the gradient-estimation network using at least one AMRB. In some embodiments, the AMRB may include a first convolutional layer of a first dimension, a second convolutional layer of a second dimension smaller than the first dimension, and a channel attention layer.

In some embodiments, the fusion network may fuse the first depth-edge information and the second depth-edge information to generate the residual map using at least one AMRB and a residual convolutional layer.

In some embodiments, the first depth image may be associated with a first resolution. In some embodiments, the second depth image may be associated with a second resolution lower than the first resolution. In some embodiments, the third depth image may have a third resolution equal to the first resolution.

In some embodiments, the memory storing instructions, which when executed by at least one processor, may further cause the processor to interpolate the second depth image to generate the first depth image.

In some embodiments, the second depth image may be interpolated using bicubic upsampling to generate the first depth image.

According to a further aspect of the present disclosure, a non-transitory computer-readable medium storing instructions for an image-processing system is provided. The memory storing instructions, which when executed by the at least one processor, may cause the at least one processor to input a first color image and a first depth image into a gradient-estimation network. The memory storing instructions, which when executed by the at least one processor, may cause the at least one processor to perform gradient-estimation of the first color image and the first depth image using the gradient-estimation network to generate first depth-edge information. The memory storing instructions, which when executed by the at least one processor, may cause the at least one processor to input a second depth image and the first depth-edge information into a depth-upsampling network. The memory storing instructions, which when executed by the at least one processor, may cause the at least one processor to perform depth upsampling of the second depth image and the first depth-edge information to generate second depth-edge information. The memory storing instructions, which when executed by the at least one processor, may cause the at least one processor to input the first depth-edge information and the second depth-edge information into a fusion network. The memory storing instructions, which when executed by the at least one processor, may cause the at least one processor to fuse the first depth-edge information and second depth-edge information using a fusion network to generate a residual map. The memory storing instructions, which when executed by the at least one processor, may cause the at least one processor to combine the first depth image and the residual map to generate a third depth image.

In some embodiments, the gradient-estimation may be performed by the gradient-estimation network using at least one AMRB. In some embodiments, the AMRB may include a first convolutional layer of a first dimension, a second convolutional layer of a second dimension smaller than the first dimension, and a channel attention layer.

In some embodiments, the fusion network may fuse the first depth-edge information and the second depth-edge information to generate the residual map using at least one AMRB and a residual convolutional layer.

In some embodiments, the first depth image may be associated with a first resolution. In some embodiments, the second depth image may be associated with a second resolution lower than the first resolution. In some embodiments, the third depth image may have a third resolution equal to the first resolution.

In some embodiments, the instructions, which when executed by at least one processor, may further cause the processor to interpolate the second depth image to generate the first depth image.

In some embodiments, the second depth image may be interpolated using bicubic upsampling to generate the first depth image.

According to yet a further aspect of the present disclosure, a method of training an image-enhancement system is provided. The method may include generating, by at least one processor, a first loss function based on a first mask-loss function and an edge map. The method may include training, by the at least one processor, an output of the gradient-estimation network using the first loss function. The method may include generating, by the at least one processor, a second loss function based on a second mask-loss function and at least one depth map. The method may include training, by the at least one processor, one or more of a low-resolution depth upsampling network or a fusion network based on the second loss function.

In some embodiments, the method may include generating, by the at least one processor, an SSIM loss function based on a ground-truth depth image and a super-resolution depth image. In some embodiments, the method may include generating, by the at least one processor, a third loss function based on the SSIM loss function. In some embodiments, the method may include training, by the at least one processor, the one or more of a low-resolution depth upsampling network or the fusion network based on the third loss function.

According to still another aspect of the present disclosure, a system for training an image-processing device is provided. The system may include at least one processor and memory storing instructions. The memory storing instructions, which when executed by the at least one processor, cause the at least one processor to generate a first loss function based on a first mask-loss function and an edge map. The memory storing instructions, which when executed by the at least one processor, cause the at least one processor to train an output of the gradient-estimation network using the first loss function. The memory storing instructions, which when executed by the at least one processor, cause the at least one processor to generate a second loss function based on a second mask-loss function and at least one depth map. The memory storing instructions, which when executed by the at least one processor, cause the at least one processor to train one or more of a low-resolution depth upsampling network or a fusion network based on the second loss function.

In some embodiments, the memory storing instructions, which when executed by the at least one processor, further cause the at least one processor to generate an SSIM loss function based on a ground-truth depth image and a super-resolution depth image. In some embodiments, the memory storing instructions, which when executed by the at least one processor, further cause the at least one processor to generate a third loss function based on the SSIM loss function. In some embodiments, the memory storing instructions, which when executed by the at least one processor, further cause the at least one processor to train the one or more of a low-resolution depth upsampling network or the fusion network based on the third loss function.

According to yet a further aspect of the present disclosure, a non-transitory computer-readable medium storing instructions for an image-processing training system may be provided. The instructions, which when executed by the at least one processor, cause the at least one processor to generate a first loss function based on a first mask-loss function and an edge map. The instructions, which when executed by the at least one processor, cause the at least one processor to train an output of the gradient-estimation network using the first loss function. The instructions, which when executed by the at least one processor, cause the at least one processor to generate a second loss function based on a second mask-loss function and at least one depth map. The instructions, which when executed by the at least one processor, cause the at least one processor to train one or more of a low-resolution depth upsampling network or a fusion network based on the second loss function.

In some embodiments, the instructions, which when executed by the at least one processor, further cause the at least one processor to generate an SSIM loss function based on a ground-truth depth image and a super-resolution depth image. In some embodiments, the instructions, which when executed by the at least one processor, further cause the at least one processor to generate a third loss function based on the SSIM loss function. In some embodiments, the instructions, which when executed by the at least one processor, further cause the at least one processor to train the one or more of a low-resolution depth upsampling network or the fusion network based on the third loss function.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method of image processing, applied to a decoder and comprising:
inputting, by at least one processor, a first color image and a first depth image into a gradient-estimation network;
performing, by the at least one processor, gradient-estimation of the first color image and the first depth image using the gradient-estimation network to generate first depth-edge information;
inputting, by the at least one processor, a second depth image and the first depth-edge information into a depth-upsampling network;
performing, by the at least one processor, depth upsampling of the second depth image using the first depth-edge information to generate second depth-edge information;
inputting, by the at least one processor, the first depth-edge information and the second depth-edge information into a fusion network;
fusing, by the at least one processor, the first depth-edge information and second depth-edge information using the fusion network to generate a residual map; and
combining, by the at least one processor, the first depth image and the residual map to generate a third depth image.

2. The method of claim 1, wherein:
the gradient-estimation is performed by the gradient-estimation network using at least one attention-based multilevel residual block (AMRB), and
the AMRB includes a first convolutional layer of a first dimension, a second convolutional layer of a second dimension smaller than the first dimension, and a channel attention layer.

3. The method of claim 1, wherein the fusion network fuses the first depth-edge information and the second depth-edge information to generate the residual map using at least one attention-based multilevel residual block (AMRB) and a residual convolutional layer.

4. The method of claim 1, wherein:
the first depth image is associated with a first resolution,
the second depth image is associated with a second resolution lower than the first resolution, and
the third depth image is associated with a third resolution equal to the first resolution.

5. The method of claim 1, further comprising:
interpolating, by the at least one processor, the second depth image to generate the first depth image.

6. The method of claim 5, wherein the second depth image is interpolated using bicubic upsampling to generate the first depth image.

7. A method of image processing, applied to an encoder and comprising:
inputting, by at least one processor, a first color image and a first depth image into a gradient-estimation network;
performing, by the at least one processor, gradient-estimation of the first color image and the first depth image using the gradient-estimation network to generate first depth-edge information;
inputting, by the at least one processor, a second depth image and the first depth-edge information into a depth-upsampling network;
performing, by the at least one processor, depth upsampling of the second depth image using the first depth-edge information to generate second depth-edge information;
inputting, by the at least one processor, the first depth-edge information and the second depth-edge information into a fusion network;
fusing, by the at least one processor, the first depth-edge information and second depth-edge information using the fusion network to generate a residual map; and
combining, by the at least one processor, the first depth image and the residual map to generate a third depth image.

8. The method of claim 7, wherein:
the gradient-estimation is performed by the gradient-estimation network using at least one attention-based multilevel residual block (AMRB), and
the AMRB includes a first convolutional layer of a first dimension, a second convolutional layer of a second dimension smaller than the first dimension, and a channel attention layer.

9. The method of claim 7, wherein the fusion network fuses the first depth-edge information and the second depth-edge information to generate the residual map using at least one attention-based multilevel residual block (AMRB) and a residual convolutional layer.

10. The method of claim 7, wherein:
the first depth image is associated with a first resolution,
the second depth image is associated with a second resolution lower than the first resolution, and
the third depth image is associated with a third resolution equal to the first resolution.

11. The method of claim 7, further comprising:
interpolating, by the at least one processor, the second depth image to generate the first depth image.

12. The method of claim 5, wherein the second depth image is interpolated using bicubic upsampling to generate the first depth image.

13. A non-transitory computer-readable medium storing instructions and a bitstream, wherein when executed by a processor, the instructions cause the processor to perform the following to generate the bitstream:
inputting a first color image and a first depth image into a gradient-estimation network:
performing gradient-estimation of the first color image and the first depth image using the gradient-estimation network to generate first depth-edge information;
inputting a second depth image and the first depth-edge information into a depth-upsampling network:
performing depth upsampling of the second depth image and the first depth-edge information to generate second depth-edge information;
inputting the first depth-edge information and the second depth-edge information into a fusion network:
fusing the first depth-edge information and second depth-edge information using the fusion network to generate a residual map; and
combining the first depth image and the residual map to generate a third depth image.

14. The non-transitory computer-readable medium of claim 13, wherein:
the gradient-estimation is performed by the gradient-estimation network using at least one attention-based multilevel residual block (AMRB), and
the AMRB includes a first convolutional layer of a first dimension, a second convolutional layer of a second dimension smaller than the first dimension, and a channel attention layer.

15. The non-transitory computer-readable medium of claim 13, wherein the fusion network fuses the first depth-edge information and the second depth-edge information to generate the residual map using at least one attention-based multilevel residual block (AMRB) and a residual convolutional layer.

16. The non-transitory computer-readable medium of claim 13, wherein:
the first depth image is associated with a first resolution,
the second depth image is associated with a second resolution lower than the first resolution, and
the third depth image is associated with a third resolution equal to the first resolution.

17. The non-transitory computer-readable medium of claim 13, wherein the instructions, which when executed by at least one processor, further cause the processor to:
interpolate the second depth image to generate the first depth image.

18. The non-transitory computer-readable medium of claim 17, wherein the second depth image is interpolated using bicubic upsampling to generate the first depth image.
